(19) United States
(12) Patent Application Publication
(10) Pub. No.: US 2006/0232058 A1
(43) Pub. Date: Oct. 19, 2006

(54) Value document and method and device for the production thereof

(76) Inventors: Monika Girnghuber, Munich (DE); Petra Roerig, Mering (DE); Christian Schaller, Munich (DE); Rainer Sueggeler, Munich (DE)

Correspondence Address: ROTHWELL, FIGG, ERNST & MANBECK, P.C., 1425 K STREET, N.W., SUITE 800, WASHINGTON, DC, 20005, US

(21) Appl. No.: 10/513,665

(22) PCT Filed: May 7, 2003
(86) PCT No.: PCT/EP03/04791

§ 371 Date: May 10, 2006

(30) Foreign Application Priority Data
May 8, 2002 (DE) 10220641.4

(51) Int. Cl. B42D 15/00

(52) U.S. Cl. 283/72

(57) ABSTRACT

The invention relates to a paper of value (1) with at least one security feature (3), in particular a bank note (1), as well as a method and an apparatus for producing such a paper of value (1).

By virtue of e.g. bank notes (1) being produced with at least one rounded corner area (4a-d, 4a′-d′), the likelihood of the formation of dog-ears and thus of jams during automatic tests in bank note processing machines is reduced.

### CROSS-REFERENCE TO RELATED APPLICATION

This application is a National Phase of International Application Serial No. PCT/EP03/04791, filed May 7, 2003.

1. Field of the Invention

The invention relates to a paper of value with at least one security feature, in particular a bank note, as well as a method and an apparatus for producing such a paper of value.

2. Background of the Art

Although not restricted to this, the invention in the following is described with reference to the particular problem of bank notes, which constitute a special kind of papers of value. For nearly thirty years bank notes have been provided with machine-readable security features, as to being able to have them automatically tested with the aid of processing machines. Such bank notes are marked as authentic not solely by their printed image, but have one or several further security features, which are integrated in the bank note paper or printed onto it, cannot be reproduced to be deceiving by techniques of photocopying and e.g. can be machine-tested either electrically, magnetically or optically.

A pertinent processing machine is explained as an example in DE 198 10 928 A1, with which bank notes are put down in a stacked fashion, separately fed into the machine, and transported to different storage compartments according to predetermined criteria. With such sorter apparatuses or with cash dispensers, where bank notes are paid in, there is a potential danger of a jam when feeding or transporting the bank notes. In particular in case of worn bank notes such a jam regularly is due to dog-ears, i.e. the bank notes have bent over corner areas, which are caught in the transport mechanism.

On these premises, it is the problem of the present invention to reduce the likelihood of jams when bank notes or other papers of values with machine-readable security features are automatically tested.

### SUMMARY OF THE INVENTION

The invention therefore is founded on the idea to produce bank notes with at least one rounded corner area. This means, that in the rounded corner areas the bank note lacks a part of the surface clearly visible even without the aid of optical instruments, compared to the rectangular form of known bank notes.

This leads to the fact, that the bank notes in the corner areas have an increased stiffness against bending over, as a result of which the likelihood of the formation of dog-ears and thus of jams during automatic tests in processing machines is reduced, without having to change the design of the machines. An additional advantage is the fact, that the sorting in of such bank notes to a purse by hand is improved due to the absent dog-ears.

The invention is particularly advantageous for papers of value made of cotton fibers or other vegetable fibers, such as e.g. cellulose, since such paper is particularly subject to bending over and getting dog-ears. However, the concept paper of value within the framework of the invention also means all other substrates usable for papers of value, such as plastic-fiber-like, pure plastic fiber papers or foil-like plastic substrates, although with these the problem of dog-ears does occur less often due to their higher elasticity.

According to a preferred embodiment the rounded corner area will have n corner points, n being a natural number greater than or equal to 2. This means e.g., that in the pertinent corner area there are two or several corner points, wherein either two straight contour lines or two curved contour lines collide with each other. The corner points preferably will have internal angles that are greater than 90° and smaller than 180°. Contrary to this, the corner area of a known rectangular bank note has only one corner point with a 90°-internal angle.

The rounded corner areas preferably will be smooth, i.e. will not have any patches showing a discontinuity and/or fold. This can apply to the area between two neighbouring corner points, which lead on to the horizontally or vertically extending sides of an otherwise rectangular bank not. But especially preferred, this condition applies to the entire circumference, i.e. the entire contour of the bank not.

The rounded corner area here can have for example a contour line with continuous curvature, such as e.g. a circular-arc-shaped and/or elliptical-arc-shaped and/or hyperbolic-arc-shaped and/or parabolic-arc-shaped contour line. With these variations the formation of dog-ears can be prevented particularly reliably.

In particular with processing machines, which test the bank notes independently of their position, it is preferred that all corner areas of the individual bank notes in addition especially preferred are rounded in the same fashion.

For producing the inventive papers of value in addition an apparatus and a pertinent method is proposed, with which by means of a severing device one sheet of a printed or unprinted security paper, having one copy or several copies for producing one or several of such papers of value, is severed into single copies corresponding to the individual papers of value, and by means of a rounding device at least one corner of the single copies is rounded.

Preferably, the severing device will carry out the function of the rounding device as well. This means, that the severing and the rounding is effected in one processing step. Compared to a sequential processing, with which the rounding of the corners is effected in a separate step after the severing into single copies, the above variation can be carried out substantially faster.

The severing and/or rounding is effected preferably by punching, the punching device being e.g. a grid with several grid cells, the form of a grid cell corresponding to the contour of one single copy. This means, for example, that the corner areas of the walls of the individual grid cells can also be formed round, so that by punching out the single copies from the sheet at the same time also the corners are punched out in the desired rounded form. Since, in addition, several single copies are punched out simultaneously, this variation is particularly time-effective

### BRIEF DESCRIPTION OF THE DRAWINGS

Further advantages and embodiments are explained with reference to the figures.

FIG. 1 shows a bank note according to a first embodiment in a top view with an enlarged representation of the corner area on the bottom left,

FIG. 2 shows a bank note according to a second embodiment in a top view with an enlarged representation of the corner area on the bottom left,

FIG. 3 shows a sheet for producing bank notes according to FIG. 2,

FIG. 4 shows a punching device for producing bank notes according to FIG. 2 in accordance with a first inventive method and

FIG. 5 shows a top view onto a single copy for producing a bank note according to FIG. 2 in accordance with a second inventive method.

### DETAILED DESCRIPTION OF THE INVENTION

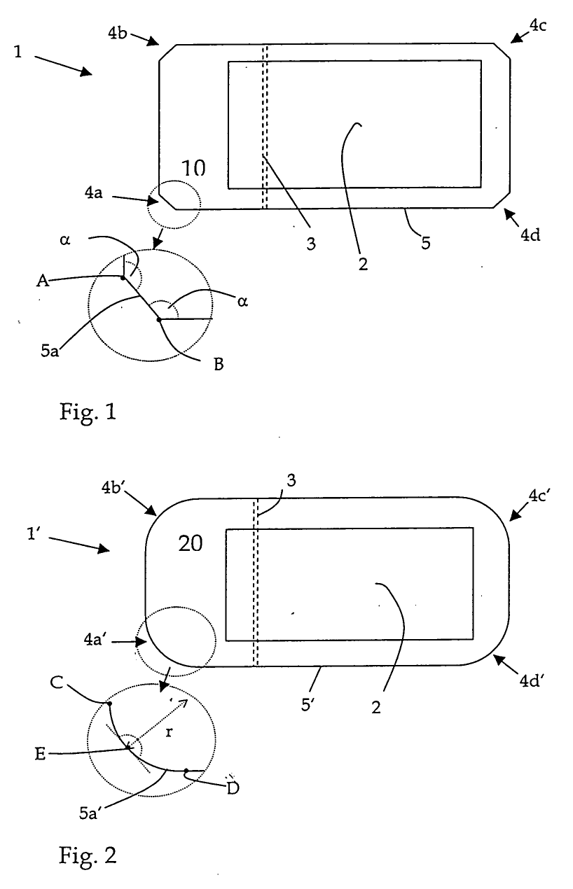

FIG. 1 shows an inventive paper of value in a top view. The shown example is a bank note 1 made of paper, such as for example cotton paper. This bank note 1, in particular in the schematically outlined area 2, has a printed image, which is specific for the denomination of the bank note. In addition, the bank note is provided with several machine-readable security features. The paper or the printing ink will contain fluorescent and/or phosphorescent pigments and the bank note will have individual areas with magnetic substances. Furthermore, a security thread 3 can be incorporated in the bank note paper, which can be magnetically encoded. The bank note, of course, can have other or further security features.

The bank note 1 is marked by the fact that in all four corner areas 4a-d it is produced in a rounded fashion, so that the bank note 1 in the corner areas 4a-d lacks a visually clearly visible part of the surface, compared to the rectangular form of known bank notes. Whereas known bank notes have a rectangular contour with an internal angle of 90° in the corner areas, this contour 5 of the inventive bank note 1 deviates from that and these internal angles are enlarged.

As it can be recognized in the enlarged detail showing the corner area 4a, this means, for example for the bank note 1 shown in FIG. 1, that the corner area 4a has a line 5a with two corner points A and B, which forms an internal angle α with the adjoining contour lines, that is larger than 90°, and specifically amounts to approximately 130°. The lack of right and acute angles leads to the fact, that the bank note 1 in the corner areas 4a-d has an increased stiffness against bending over, as a result of which the likelihood of the formation of dog-ears and thus of jams during the automatic test of the bank note 1 in processing machines is reduced. The internal angles α at the points A and B not necessarily have to be of the same size, but can be of a differently selected size. In addition, not only a 2-corner can be selected, but also a contour line with more than two corners, the form of the contour line coming closer to a line with continuous curvature with increasing number of corners.

FIG. 2 shows a second example of such an inventive bank note 1′. This bank note differs from the bank note 1 according to FIG. 1 in particular by the type of rounding of the corner areas 4a′-d′. As illustrated in the enlarged detail of FIG. 2, the contour 5′ of the bank note 1′ is not rounded by a straight line 5a as shown in FIG. 1, but has at least in the area between two limiting points C and D a contour line 5a′ with continuous curvature, i.e. without any discontinuities in the course of the change of the curvature. In the specific case the bank note 1′ has a circular-arc-shaped contour line 5a′ in the corner area 4a′ and is smoothly designed without any discontinuities or folds along its entire circumference. The radius r of the circular arc 5a′ amounts to approximately 1 centimeter and any point E between the points C and D has an internal angle β of 180°, corresponding to the course of the tangent line at the point E.

Since the contour 5′ at least in the corner areas 4a′-d′, i.e. in the areas between the vertically and horizontally extending sections shown in FIG. 2, has a contour line 5a′ with continuous curvature, the stiffness against bending over is increased to a particularly high degree. This becomes particularly clearly apparent and thus the likelihood of dog-ears is reduced, if the radius r is greater than or equal to 0.5 centimeter, preferably greater than or equal to 0.7 centimeter and especially preferred greater than or equal to 1.0 centimeter.

It shall be emphasized, that the continuously curved contour line 5a′ can also have another form, such as e.g. one according to an ellipse, hyperbola, parabola or a combination of these individual forms. In this case the amount of the pertinent radius vector or the semifocal chord of the contour line preferably should meet the above-mentioned requirements. Furthermore, the contour line also can be composed of a combination of the above-mentioned different types of lines.

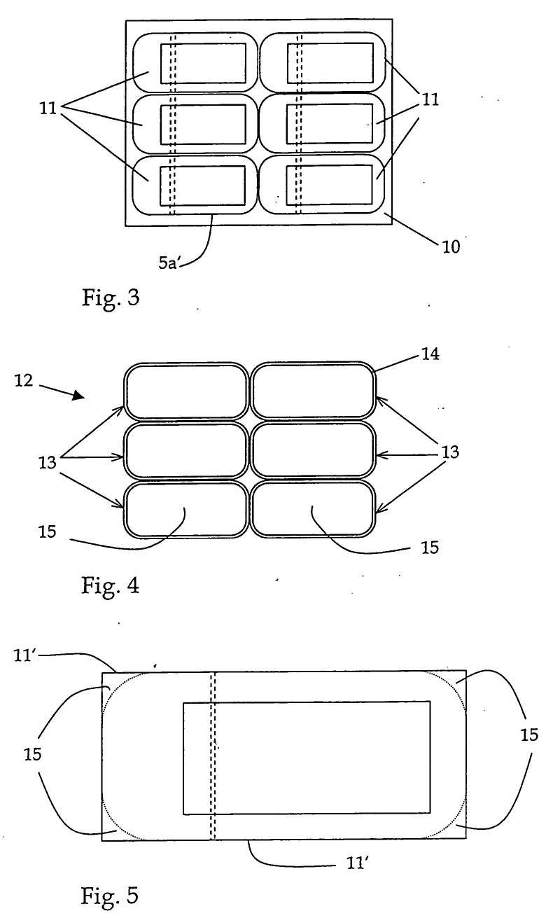

With reference to FIGS. 3 and 4 a possible procedure for producing inventive papers of value is explained in the following. By way of example, one possibility for producing the bank notes 1′ according to FIG. 2 is explained in detail. In the way known in the art a sheet 10 is provided, which consists of security paper with machine-readable security features, such as e.g. the security thread 3, and preferably has already been printed. An individual sheet 10 has a matrix of several single copies 11 corresponding to the individual bank notes 1′. For clarity's sake in FIG. 3 merely a matrix of 3×3 single copies 11 is shown, however, there can be, of course, more single copies per sheet.

FIG. 4 shows in a schematic top view a possible tool for severing the single copies 11 from the sheet 10 according to FIG. 3. In this case the tool is a grid-shaped punching device 12. It has, by way of example, 3×3 grid cells 13, which are fastened rigidly to each other. The individual grid cells 13 consist of surrounding walls 14, which each bound a hollow interior space 16 in the form of the contour line 5′ of one of the single copies 11. The grid cells 13 here are disposed on the sheet 10 according to the position of single copies 11 to be punched out. That means, the individual grid cells each can punch out one pertinent single copy 11 from the sheet 10. Since the walls 14 of the grid cells 13 already have the desired form of rounded corners, by means of this punching device 12 several single copies 11 with the desired inventive contour can be severed from the sheet 10 at the same time. Therefore, in this case after the severing process the single copies 11 already correspond to the desired bank notes 1′.

With such a proceeding especially preferred several sheets 10 are stacked flush one above the other, and then by pressing the punching device 12 on and through the upper sheet a respective number of single copies 11 is severed from the stacked sheets.

Beside the mentioned punching method, the single copies 11 can be severed in the desired form with rounded corner areas also by a milling method or other cutting methods. For this purpose e.g. cutting knives are used, which are moved along the desired contour relative to the sheets 10.

Though, one problem when severing the bank notes with curved, such as e.g. circular-shaped, contour lines 5a′ is, that the cutting tools cannot be guided only in a straight line. In such a case beside the use of cutting knives the employment of a laser beam as a cutting tool is of much advantage. If a point laser beam is used, whose cross section is small in comparison to the length of the contour line 5a′ to be rounded, then the pertinent laser has to be moved e.g. on a positioning framework merely in the desired directions. When using cutting knives, which mostly have greater dimensions in comparison to the length of the contour line 5a′ to be rounded, however, possibly also a turning of the knife will become necessary during the cutting process along the curved contour line.

While in the above it was described that the severing of the single copies at the same time effects the rounding of the corner areas 4a-d′ by means of an adequate shaping of the walls 14 of the grid cells 13, basically it is also thinkable, that these steps occur separately. For example, the single copies can be cut out and/or punched in the known rectangular form from the security paper sheets 10 by usual severing processes. FIG. 5 shows an example for such an individual single copy 11′ with rectangular contour 5″. Several of such single copies 11 can be stacked flush and then, by means of a separate severing step, the corner pieces 15 to be removed can be cut off or punched, so that afterwards the single copies have the desired form with rounded corners corresponding to the dashed lines as shown in FIG. 5.

Consequently, by means of the inventive proceeding the likelihood of dog-ears and thus of jams during the automatic test in bank note processing machines is reduced, without having to change the design of these machines.

1. Bank note (1, 1′) with at least one security feature (3), characterized in that the bank note (1, 1′) is produced with at least one rounded corner area (4a-d, 4a′-d′).

2. Bank note according to claim 1, characterized in that the rounded corner area (4a-d, 4a′-d′) has contour lines (5a) in the form of an n-corner, n being a natural number greater than or equal to 2.

3. Bank note according to claim 1, characterized in that the corners of the n-corner have an internal angle (α, β), which is greater than 90°.

4. Bank note according to claim 1, characterized in that the rounded corner area (4a-d, 4a′-d′) has at least one of a smooth contour line (5a′) or a contour line (5a′) with continuous curvature.

5. Bank note according to claim 1, characterized in that the contour line (5a′) has a radius (r) or radius vector or semifocal chord of an amount greater than or equal to 0.5 centimeter.

6. Bank note according to claim 1, characterized in that all corner areas (4a-d, 4a′-d′) of the bank note (1, 1′) are rounded.

7. Bank note according to claim 1, characterized in that all rounded corner areas (4a-d, 4a′-d′) of the bank note (1, 1′) have a same contour line (5a, 5a′).

8. Method for producing bank notes (1, 1′) with at least one security feature (3) and with at least one rounded corner area (4a-d, 4a′-d′), the method comprising the following steps:
providing a sheet (10) of a printed or unprinted security paper with one or several single copies (11, 11′) for producing one or several bank notes (1, 1′),
severing the sheet (10) into single copies (11, 11′) corresponding to the individual bank notes (1, 1′) and
rounding at least one corner area (4a-d, 4a′-d′) of the single copies (11, 11′).

9. Method according to claim 8, characterized in that the rounding is effected after the sheet (10) having been severed into single copies (11′) or while the sheet (10) is severed into single copies (11).

10. Method according to claim 8, characterized in that at least one of the severing or rounding is effected by at least one of punching or milling.

11. Method according to claim 8, characterized in that at least one of the severing or rounding is effected by cutting.

12. Method according to claim 8, characterized in that several sheets (10) are severed into single copies at the same time.

13. Apparatus for producing bank notes (1, 1′) with at least one security feature (3) and with at least one rounded corner area (4a-d, 4a′-d′), the apparatus comprising the following:
a severing device (12) for severing a sheet (10) of a printed or unprinted security paper, with one or several copies (11, 11′) for producing one or several bank notes (1, 1′), into single copies (11, 11′) corresponding to the individual bank notes (1, 1′) and
a rounding device (12) for rounding at least one corner area (4a-d, 4a′-d′) of the single copies (11, 11′).

14. Apparatus according to claim 13, characterized in that the severing device (12) carries out the function of the rounding device (12).

15. Apparatus according to claim 13, characterized in that at least one of the severing device (12) or rounding device (12) has at least one of a punching device (12) or a milling device.

16. Apparatus according to claim 15, characterized in that the punching device (12) has a form of a grid, one grid cell (13) corresponding to the contour (5, 5′) of one of the single copies (11, 11′).

17. Apparatus according to claim 13, characterized in that at least one of the severing device (12) or rounding device (12) has a cutting device.

18. The bank note of claim 4 wherein said contour line is at least one of circular-arc-shaped, elliptical-arc-shaped, hyperbolic-arc-shaped or parabolic-arc-shaped.

19. The bank note of claim 5 wherein said amount is greater than or equal to 0.7 cm.

20. The bank note of claim 5 wherein said amount is greater than or equal to 1.0 cm.

21. The method of claim 11 wherein said cutting is effected by at least one of a cutting knife or a laser beam.

22. The apparatus of claim 17 wherein said cutting device comprises at least one of a cutting knife or a laser beam cutting beam.
